(19) United States
(12) Patent Application Publication
(10) Pub. No.: US 2026/0012904 A1
(43) Pub. Date: Jan. 8, 2026

(54) SENSING DEVICES ARRANGED IN PREDETERMINED SPACE, AND METHOD FOR LINKING SAME

(71) Applicant: WILLOG CO., LTD., Seoul (KR)

(72) Inventors: Sunghoon BAE, Seoul (KR); Jihyun YUN, Seoul (KR); Jaehwan KIM, Seoul (KR)

(73) Assignee: WILLOG CO., LTD., Seoul (KR)

(21) Appl. No.: 19/128,690

(22) PCT Filed: Nov. 10, 2023
(86) PCT No.: PCT/KR2023/018115

§ 371 Date: May 9, 2025

(30) Foreign Application Priority Data
Nov. 10, 2022 (KR) 10-2022-0149744
Nov. 9, 2023 (KR) 10-2023-0154930

(51) Int. Cl. H04W 56/00; H04W 24/02

(52) U.S. Cl. CPC H04W 56/001; H04W 24/02

(57) ABSTRACT

The method for linking a plurality of sensing devices according to the present disclosure may include: generating, by a first sensing device disposed in a predetermined space, a first search signal to search for other sensing devices; generating, by a second sensing device disposed in the space, a first synchronization signal in response to the first search signal; logically connecting, by the first sensing device, the second sensing device in response to receiving the first synchronization signal; generating, by the first sensing device, a connection tree as a data structure representing logical connection relationships with other sensing devices; and generating, by the second sensing device, a second search signal to search for another sensing device.

### FIELD OF THE INVENTION

The embodiments disclosed herein relate to a method of linking sensing devices, and more specifically, to a method for linking a plurality of sensing devices arranged in a predetermined space.

When products are damaged due to inappropriate temperature, vibration, humidity, or other conditions during the logistics transportation process, there is a high possibility that other products within the logistics transportation space will also be damaged in succession. Such risks are even more critical for high-value products.

To address this issue, the cargo visibility technology, which visualizes various information about the condition of cargo by attaching sensing devices that measure temperature, humidity, etc., within the logistics transportation space or directly to the products, has emerged. However, despite multiple sensing devices being located within the same space, diversified information regarding the logistics transportation space through interlinking of these sensing devices has not yet been effectively obtained.

### BACKGROUND OF THE RELATED ART

The embodiments disclosed herein aim to solve various issues, including the above-mentioned problems, by providing a method for linking a plurality of sensing devices placed in a predetermined space, such as a logistics transportation space. However, these problems are merely examples and do not limit the scope of the disclosure.

### SUMMARY OF THE INVENTION

According to one aspect of the present disclosure, a method for linking a plurality of sensing devices is provided.

According to an embodiment, the method for linking a plurality of sensing devices includes: generating a first search signal by a first sensing device arranged in a predetermined space to search for other sensing devices; generating a first synchronization signal by a second sensing device arranged in the space in response to the first search signal; logically linking the second sensing device upon reception of the first synchronization signal by the first sensing device; generating a connection tree, which is a data structure representing the logical connection relationship with other sensing devices, by the first sensing device; and generating a second search signal by the second sensing device to search for other sensing devices.

According to another embodiment, the method for linking a plurality of sensing devices further includes: logically linking a third sensing device upon reception of a second synchronization signal by the second sensing device; providing the connection relationship of the second sensing device to the first sensing device; and updating the connection tree based on the connection relationship by the first sensing device.

According to yet another embodiment, the method for linking a plurality of sensing devices includes: storing a connection relationship with the nearest sensing device that transmitted the first received synchronization signal in the first operation mode; or storing a connection relationship with an interest sensing device located in an interest area among the plurality of received synchronization signals in the second operation mode.

Further, the method for linking a plurality of sensing devices includes: clustering multiple sensing devices as a single logical group when the time difference between the first received synchronization signal and the second received synchronization signal is below a threshold.

Moreover, the method includes: storing a connection relationship with the first sensing device upon reception of the first synchronization signal by the second sensing device; stopping the generation of a synchronization signal by a fourth electronic device upon receiving the first synchronization signal in response to the first search signal; ensuring at least one of the plurality of sensing devices is attached to cargo within a cargo loading space; and limiting each sensing device to generating a synchronization signal only once.

Additionally, the method includes terminating the generation of the connection tree when there is no response synchronization signal to the second search signal transmitted by the second sensing device.

A sensing device placed in a predetermined space according to an embodiment of the present disclosure includes: a memory, a communication module configured to support short-range communication with other sensing devices, a sensor subsystem configured to sense environmental information including temperature or humidity, and a processor configured to generate a connection tree according to the connection relationship with other sensing devices and process sensing information.

Various other aspects, features, and advantages will become apparent from the following detailed description, claims, and drawings. Furthermore, these general and specific aspects may be implemented using a system, method, computer program, or any combination thereof.

According to exemplary embodiments of the present disclosure, when multiple sensing devices are placed within a predetermined space, each sensing device sequentially interlinks with others, thereby establishing a foundation for obtaining diversified information about the space.

According to exemplary embodiments, sensing devices can be logically connected with other nearby sensing devices through the communication of search and synchronization signals, allowing the construction of a connection tree.

Furthermore, by maintaining the connection relationships of all sensing devices within the predetermined space via the connection tree, the system can monitor the loss or theft of one or more sensing devices and/or cargo by receiving sensing and location information from other sensing devices.

Additionally, since each sensing device is interconnected with all other sensing devices within the predetermined space, it becomes possible to confirm whether the necessary number of sensing devices has been installed or collected. Moreover, when the sensing devices are individually attached to cargo, the system can verify whether the correct quantity of cargo has been loaded or unloaded.

Of course, the scope of the present disclosure is not limited by these effects.

### BRIEF DESCRIPTION OF THE DRAWINGS

FIG. 1 is a block diagram schematically illustrating a sensing device according to an exemplary embodiment.

FIG. 2 is a conceptual diagram schematically illustrating the interlinking of multiple sensing devices according to an exemplary embodiment.

FIG. 3 is a conceptual diagram schematically illustrating sensing devices arranged in a predetermined space according to an exemplary embodiment.

FIG. 4 is a flowchart explaining the interlinking of sensing devices according to an exemplary embodiment.

FIG. 5 is a relational diagram schematically illustrating a connection tree for interlinking sensing devices according to an exemplary embodiment.

FIG. 6 is a conceptual diagram schematically illustrating sensing devices arranged in a predetermined space according to another exemplary embodiment.

FIG. 7 is a flowchart explaining the interlinking of sensing devices according to another exemplary embodiment.

FIG. 8 is a relational diagram schematically illustrating a connection tree for interlinking sensing devices according to another exemplary embodiment.

FIGS. 9a-9e are conceptual diagrams schematically illustrating sensing devices arranged in a predetermined space according to different exemplary embodiments.

FIG. 10 is a flowchart explaining the method for placing sensing devices in a predetermined space according to an exemplary embodiment.

FIG. 11 is a three-dimensional image illustrating a transportation space with temperature measurement sensors according to an exemplary embodiment.

FIG. 12 is a schematic heat map image showing temperature measurement and estimation within a cargo transportation space according to an exemplary embodiment.

### DETAILED DESCRIPTION OF THE PREFERRED EMBODIMENT

The present disclosure is capable of undergoing various modifications and may have multiple embodiments. Specific embodiments will be illustrated in the drawings and described in detail in the following description. The effects and features of the present disclosure, as well as the methods for achieving them, will become clear when referring to the embodiments detailed below in conjunction with the drawings. However, the present disclosure is not limited to the embodiments disclosed below and can be implemented in various forms.

In the embodiments described below, terms such as “first” and “second” are not used in a limiting sense but are employed to distinguish one component from another. Additionally, singular expressions shall be understood to include plural expressions unless explicitly indicated otherwise by the context.

Terms such as “include” or “have” in the following embodiments indicate the presence of specific features or components and do not preclude the addition of one or more other features or components. Furthermore, when describing that a layer, region, or component is “on” or “above” another component, it includes cases where the layer, region, or component is directly on the other component and cases where there are intervening layers, regions, or components in between.

For the convenience of explanation, the sizes of components in the drawings may be exaggerated or reduced. For example, the size and thickness of each component shown in the drawings are arbitrarily depicted for illustrative purposes, and the disclosure is not necessarily limited to the illustrations. Moreover, the sequence of certain operations may differ from the described order in alternative implementations. For instance, two consecutive steps described in sequence may actually be performed simultaneously or in the reverse order.

The phrase “A and/or B” means A, B, or both A and B. Likewise, the phrase “at least one of A and B” means A, B, or both. Additionally, when stating that layers, regions, or components are “connected,” this includes both direct connections and indirect connections where other layers, regions, or components are interposed. For example, if an element is described as being “electrically connected,” it includes both direct electrical connections and indirect electrical connections with intermediate elements.

The x-axis, y-axis, and z-axis are not necessarily limited to an orthogonal coordinate system and may be interpreted more broadly. These axes may be orthogonal to each other or may refer to different directions that are not necessarily perpendicular.

The benefits and features of this disclosure, as well as the methods for achieving them, will be further clarified through the embodiments detailed below in conjunction with the accompanying drawings. However, the disclosure is not limited to the disclosed embodiments and can be implemented in various forms. The embodiments are provided merely to ensure completeness in the disclosure and to fully inform those skilled in the technical field to which this disclosure belongs. The present disclosure is defined only by the scope of the claims.

The terminology used herein is for illustrative purposes only and is not intended to limit the present disclosure. Unless explicitly stated otherwise, the singular form shall also encompass the plural form. The terms “comprises” or “comprising,” as used throughout the disclosure, do not exclude the presence of additional components beyond those mentioned. Identical reference numerals denote the same components throughout the disclosure, and “and/or” includes each and every possible combination of the listed elements.

Even though terms such as “first” and “second” are used to describe different components, they are not limited by such terms. These terms are used merely to distinguish one component from another. Accordingly, a “first” component in the following description could also be referred to as a “second” component within the scope of the present disclosure.

The term “exemplary” is used in this disclosure to mean “serving as an example or illustration.” Any embodiment described as “exemplary” should not be construed as necessarily preferred or superior to other embodiments.

The embodiments of the present disclosure may be described in terms of a function or a block that performs a function. A block, which may be referred to as a “unit” or a “module” of the present disclosure, may be physically implemented by analog or digital circuits such as logic gates, integrated circuits, microprocessors, microcontrollers, memories, passive electronic components, active electronic components, optical components, hardwired circuits, and the like, and may optionally be driven by firmware and software. In addition, the term “unit” used in the disclosure means a hardware element such as software, an FPGA, or an ASIC, and the “unit” may perform certain roles. However, the “unit” is not limited to software or hardware. The “unit” may be configured to be on an addressable storage medium and may be configured to execute one or more processors. Thus, as an example, a “subunit” may include elements such as software elements, object-oriented software elements, class elements, and task elements, processes, functions, attributes, procedures, subroutines, segments of program code, drivers, firmware, microcode, circuitry, data, databases, data structures, tables, arrays, and variables. The functionality provided within the elements and “subunits” may be combined into a smaller number of elements and “subunits” or further separated into additional elements and “subunits”.

The embodiments of the present disclosure may be implemented using at least one software program executed on at least one hardware device. The system may also include a network management function to control elements.

The spatially relative terms “below,” “beneath,” “lower,” “above,” “upper,” and the like can be used to easily describe the relationship of one component to other components as depicted in the drawings. The spatially relative terms should be understood to include different orientations of the components when used or operated in addition to the orientations depicted in the drawings. For example, if a component depicted in the drawings is flipped over, a component described as “below” or “beneath” another component may be placed “above” the other component. Thus, the exemplary term “below” can include both the above and below orientations. The components may also be oriented in other directions, and the spatially relative terms may be interpreted accordingly.

Unless otherwise defined, all terms used in this disclosure (including technical and scientific terms) shall be interpreted as having meanings commonly understood by those skilled in the technical field. Furthermore, unless explicitly defined otherwise, common terms should not be interpreted in an idealized or excessively broad sense.

Hereinafter, embodiments of the present disclosure will be described in detail with reference to the accompanying drawings. When referring to the drawings, the same or corresponding components will be assigned the same reference numerals, and redundant descriptions will be omitted.

### 1. EXAMPLE 1

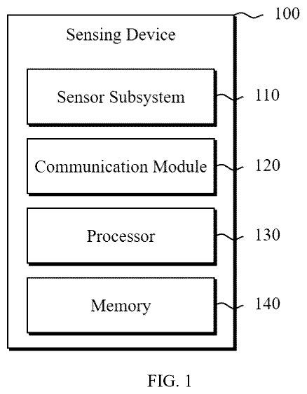

FIG. 1 is a block diagram schematically illustrating a sensing device 100 according to an exemplary embodiment of the present disclosure. According to an exemplary embodiment, the sensing device 100 may be a device incorporating cargo visibility technology that visualizes various information about the condition of cargo by measuring parameters such as temperature and humidity directly within a designated space or on a product.

Referring to FIG. 1, the sensing device 100 may include a sensor subsystem 110, a communication module 120, a processor 130, and a memory 140.

The sensor subsystem 110 may include at least one of a temperature sensor, an illumination sensor, a humidity sensor, a proximity sensor, an acceleration sensor, a gravity sensor (G-sensor), a gyroscope sensor, a motion sensor, an infrared (IR) sensor, a fingerprint recognition sensor, an optical sensor, an ultrasonic sensor, an infrared ray sensor, a geomagnetic sensor, an RGB sensor (illuminance sensor), a LiDAR (radar) sensor, a current sensor, an environmental sensor (e.g., a barometric sensor, a radiation detection sensor, a thermal detection sensor, or a gas detection sensor), a chemical sensor (e.g., a healthcare sensor, a biometric sensor, or a gas leakage monitoring sensor), and virtual sensors that perform functions corresponding to the aforementioned hardware sensors. However, the scope of the present disclosure is not limited thereto.

Here, the proximity sensor may be a sensor that detects the presence of an object approaching a predetermined detection surface or an object in its vicinity without mechanical contact by utilizing electromagnetic forces or infrared signals. These sensors may be integrated within the sensor subsystem 110, with at least one embedded therein. Since the function of each sensor can be intuitively inferred by a person skilled in the art from its name, a detailed description thereof is omitted.

The communication module 120 may transmit various information acquired in a transportation space and/or transportation environment to other sensing devices, other terminals, or a server. For example, the communication module 120 may transmit at least one type of sensing data among temperature data, humidity data, vibration data, illumination data, acceleration data, gravity data, gas data, and other diverse information sensed by the sensor subsystem 110 to other sensing devices, other terminals, or a server.

The communication module 120 communicate with external devices. Accordingly, the sensing device 100 may exchange information with external devices via a communication unit. For example, using the communication module 120, the sensing device 100 may communicate with external devices to share information sensed and generated within a logistics transportation environment. The communication module 120 may include at least one of a wired communication module, a wireless communication module, a short-range communication module, and a location information module. In an exemplary embodiment, the communication module may be configured to support short-range communication with other sensing devices.

According to an exemplary embodiment, the communication module 120 may communicate with other sensing devices that are logically connected. The communication module 120 may use various wireless communication methods such as short-range communication to transmit and receive diverse types of information, including sensing data, location information, and cargo information, to and from another sensing device determined to be logically connected through processing by the processor 130.

Here, communication, i.e., data transmission and reception, may be performed via wired or wireless means. For this purpose, the communication unit may be configured with a wired communication module that connects to the internet via a local area network (LAN), a mobile communication module that connects to a mobile communication network through a mobile communication base station, a short-range communication module supporting communication technologies such as Wi-Fi (WLAN), Bluetooth, and Zigbee (WPAN), or a satellite communication module utilizing GNSS (e.g., GPS), or a combination thereof. The wireless communication technology used for communication may include NB-IoT (Narrowband Internet of Things) for low-power communication.

For example, NB-IoT technology may be an instance of LPWAN (Low Power Wide Area Network) technology and may be implemented under LTE Cat NB1 and/or LTE Cat NB2 specifications, but it is not limited to these names. Additionally, or alternatively, the wireless communication technology implemented in various embodiments of the wireless device may perform communication based on LTE-M technology. LTE-M technology may be an instance of LPWAN technology and may be referred to by various names such as enhanced Machine Type Communication (eMTC). For instance, LTE-M technology may be implemented under at least one of the following specifications: 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M. However, it is not limited to these designations. Additionally, or alternatively, the wireless communication technology implemented in various embodiments of the wireless device may include at least one of Zigbee, Bluetooth, and LPWAN, which are considered for low-power communication. Zigbee technology, for example, may be based on IEEE 802.15.4 specifications and may create personal area networks (PANs) related to small-scale, low-power digital communication under various names.

The wired communication module may include various wired communication modules such as a local area network (LAN) module, a wide area network (WAN) module, or a value-added network (VAN) module. It may also include various cable communication modules such as USB (Universal Serial Bus), HDMI (High Definition Multimedia Interface), DVI (Digital Visual Interface), RS-232 (Recommended Standard 232), power line communication, or POTS (Plain Old Telephone Service).

The wireless communication module may include not only Wi-Fi and WiBro (Wireless Broadband) modules but also wireless communication modules that support various wireless communication standards such as GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long Term Evolution), 4G, 5G, and 6G.

The wireless communication module may include a wireless communication interface comprising an antenna and a transmitter for transmitting signals. Additionally, the wireless communication module may further include a signal conversion module that modulates a digital control signal output from the control unit into an analog wireless signal through the wireless communication interface under the control of the control unit.

The wireless communication module may include a wireless communication interface comprising an antenna and a receiver for receiving signals. Additionally, the wireless communication module may further include a signal conversion module that demodulates an analog wireless signal received via the wireless communication interface into a digital control signal.

The short-range communication module is for short-range communication and may support communication using at least one of Bluetooth™, RFID (Radio Frequency Identification), infrared communication (Infrared Data Association; IrDA), UWB (Ultra Wideband), ZigBee, NFC (Near Field Communication), Wi-Fi (Wireless Fidelity), Wi-Fi Direct, or Wireless USB (Wireless Universal Serial Bus).

The communication module 120 may further include a location information module. The location information module is a module for acquiring the location (or current position) of the sensing device 100 according to the present disclosure. A representative example of such a module includes a GPS (Global Positioning System) module or a Wi-Fi (Wireless Fidelity) module. For example, by utilizing a GPS module, the sensing device's location can be obtained using signals transmitted from GPS satellites. Alternatively, using a Wi-Fi module, the sensing device's location can be acquired based on information from a wireless access point (AP) that transmits or receives wireless signals with the Wi-Fi module. If necessary, the location information module may alternatively or additionally perform the functions of another module within the communication unit to obtain data related to the device's location. The location information module is not limited to a module that directly calculates or acquires the device's position.

The processor 130 processes, compresses, corrects, and estimates data sensed within the transportation space by the sensing subsystem 110 and controls the overall operation of the sensing device 100, such as displaying the sensed data as N-dimensional information on a display. The processor 130 may communicate with memory 140 and execute at least one instruction stored in the memory 140.

According to an exemplary embodiment of the present disclosure, the processor 130 may generate a connection tree based on the connection relationships with other sensing devices and be configured to process sensing information.

The processor 130 may store data related to an algorithm or a program reproducing an algorithm for controlling the operations of components within the device in memory 140 and perform the aforementioned operations using data stored in the memory 140. Here, the memory 140 and processor 130 may be implemented as separate chips or integrated into a single chip.

The processor 130 may consist of one or multiple cores. In this case, one or more processors may be a general-purpose processor such as a CPU, AP, or DSP (Digital Signal Processor), a graphics processor such as a GPU or VPU (Vision Processing Unit), or an artificial intelligence (AI) processor such as an NPU. The one or more processors control data processing based on pre-defined operational rules or AI models stored in memory. If the processor is an AI-dedicated processor, it may be designed with a hardware structure specialized for processing specific AI models.

The memory 140 may store data supporting various functions of the device, programs for operating the control unit, input/output data (e.g., music files, still images, videos, etc.), multiple applications executed in the system, operational data for the device, and commands. Some of these applications may be downloaded from an external server via wireless communication.

The memory 140 may store at least one instruction. The memory 140 may include at least one type of storage medium such as flash memory, hard disk type, SSD (Solid State Disk) type, SDD (Silicon Disk Drive) type, multimedia card micro type, memory cards (e.g., SD or XD memory), RAM (Random Access Memory), SRAM (Static RAM), ROM (Read-Only Memory), EEPROM (Electrically Erasable Programmable ROM), PROM (Programmable ROM), magnetic memory, magnetic disk, or optical disk. Additionally, the memory 140 may be a database that is separate from the system but connected via wired or wireless communication.

The components illustrated in FIG. 1 are not essential to implementing the method and system for integrating the sensing device with the cargo transport space according to the present disclosure. The described configurations in this specification may include more or fewer components than those listed above.

The sensing device 100 may generate sensing data related to at least one of temperature, acceleration, humidity, illumination, tilt, impact, or position inside a predetermined space (e.g., a cargo loading space or cargo transport space) where transported goods are loaded through a sensor subsystem 110 installed within the space. For example, the sensing device 100 may generate sensing data in real time or at preset intervals. It may calculate variation amounts for predetermined time intervals based on the actual sensing data and, depending on the comparison results between the variation amount and a preset threshold variation amount, activate either a first storage mode or a second storage mode.

According to an exemplary embodiment, the sensing device 100 may store sensing data using a storage method provided by the activated storage mode. Accordingly, the sensing device 100 provides a method of storing and managing logistics status information sensed within a delivery vehicle, such as temperature, acceleration, humidity, illumination, tilt, impact, or position, in a preset storage method, thereby reducing the storage volume of logistics status information data.

Additionally, the sensing device 100 can store more data on a single page by compressing the status information stored in the form of an electronic code (e.g., a QR code or barcode), and the efficiency of logistics-related work can be increased. The electronic code includes barcodes, 2D codes such as QR codes, holograms, or depth camera-based 3D codes without any restriction on its implementation form.

In the present disclosure, the sensing device 100 can be attached or detached from a predetermined space or cargo, allowing it to be affixed to a logistics transport space during transport and retrieved for reuse after the transport is completed. In an exemplary embodiment, at least one sensing device 100 may be placed (attached) within the logistics transport space.

Although not depicted in FIG. 1, the sensing device 100 may further include functions such as a display and input/output devices necessary for sensing and information display.

According to an exemplary embodiment, the input/output unit may include various interfaces or connection ports for receiving user input or outputting information to the user. The input/output unit may be divided into an input module and an output module.

The input module receives user input. It is used for inputting video information (or signals), audio information (or signals), data, or information inputted by the user and may include at least one camera, at least one microphone, and at least one user input unit. The voice or image data collected from the input unit may be analyzed and processed as user control commands.

The user input can take various forms, including key input, touch input, and voice input. Examples of input modules that can receive such user inputs include traditional keypads or keyboards, mice, and sensors that detect user touches, such as touch sensors. Additionally, microphones receive voice signals, cameras recognize gestures through image recognition, and proximity sensors, such as light sensors or infrared sensors, detect user approach. Motion sensors, including accelerometers and gyroscopes, can recognize user movements. Moreover, various other input means that sense or receive user input in diverse ways are also included in this comprehensive concept.

In an exemplary embodiment, a module provided in the sensing device 100 is designed to receive information from the user. When information is input through the input module, the processor 130 can control the operation of this device in response to the received input. The user input section may include hardware-based physical keys (e.g., buttons located on the front, back, or sides of the device, dome switches, jog wheels, jog switches, etc.) as well as software-based touch keys. For instance, touch keys can be implemented as virtual keys, soft keys, or visual keys displayed on a touchscreen through software processing, or as touch keys positioned outside the touchscreen. Furthermore, virtual keys or visual keys can take various forms and be displayed on the touchscreen. These keys may be composed of graphics, text, icons, videos, or combinations thereof.

An exemplary touch sensor can be implemented using a piezoelectric or capacitive touch sensor attached to a display panel via a touch panel or touch film. Alternatively, an optical touch sensor that detects touch based on optical principles may also be used. In addition, an input module can be implemented as an input interface (e.g., USB ports, PS/2 ports) that connects external input devices instead of detecting user input directly.

The output module provides various types of information to users. It encompasses display devices that output video, speakers (and/or connected amplifiers) that output sound, haptic devices that generate vibrations, and other diverse output means. Furthermore, an output module may be implemented as an output interface in the form of a port that connects to the aforementioned individual output means.

For example, an output module in the form of a display can present text, still images, and videos. The display may include liquid crystal displays (LCDs), light-emitting diode (LED) displays, organic light-emitting diode (OLED) displays, flat panel displays (FPDs), transparent displays, curved displays, flexible displays, 3D displays, holographic displays, projectors, and other devices that perform video output functions. Additionally, the display may be a touch display integrated with a touch sensor from the input module.

According to an exemplary embodiment, information processed in the sensing device 100 may be transmitted to an intermediate manager's user terminal or a server (including cloud servers) for post-processing.

For instance, the user terminal may include both computers and portable user terminals, or it may take the form of one or the other. Here, computers may include laptops, desktops, notebook PCs, slate PCs, or other devices equipped with a web browser. Portable user terminals may refer to wireless communication devices with portability and mobility, such as PCS (Personal Communication System), GSM (Global System for Mobile Communications), PDC (Personal Digital Cellular), PHS (Personal Handyphone System), PDA (Personal Digital Assistant), IMT-2000 (International Mobile Telecommunication-2000), CDMA-2000 (Code Division Multiple Access-2000), W-CDMA (Wideband Code Division Multiple Access), WiBro (Wireless Broadband Internet) devices, and smartphones. Furthermore, wearable devices such as watches, rings, bracelets, anklets, necklaces, glasses, contact lenses, or head-mounted devices (HMDs) may also be included.

For example, a server refers to a system that processes information through communication with external devices. It may include application servers, computing servers, database servers, file servers, game servers, mail servers, proxy servers, and web servers.

The sensing device 100 in an exemplary embodiment of the present disclosure can be logically connected with other sensing devices. A logistics integration system capable of controlling multiple sensing devices or communicating with all of them may perform the following steps: generating a first search signal from a first sensing device arranged in a given space to discover other sensing devices, generating a first synchronization signal in response to the first search signal from a second sensing device in the space, logically connecting the second sensing device upon receiving the first synchronization signal, creating a connection tree as a data structure representing logical connection relationships with other sensing devices, and generating a second search signal from the second sensing device to discover additional sensing devices.

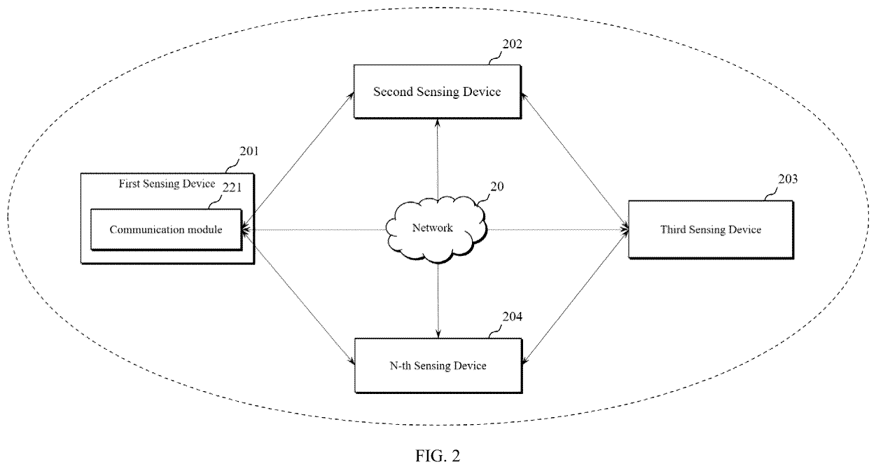

FIG. 2 is a conceptual diagram illustrating the interconnection between multiple sensing devices according to an exemplary embodiment of the present disclosure.

According to this exemplary embodiment, multiple sensing devices 201, 202, 203, 204 may be arranged within a predefined space (SPACE). In this disclosure, the predefined space (SPACE) may refer to, for example, the cargo compartment of a freight vehicle, the cargo storage of an aircraft or ship, a transportation space such as a container box for cargo transport, a reefer container, or a liner. These are physically partitioned spaces for cargo transportation. However, the concept is not limited to spaces with physical partitions; it may also include areas where a communication network 20 can be established within a certain distance from a particular sensing device, even in the absence of physical barriers.

Referring to FIG. 2, the predefined space (SPACE) may include a first sensing device 201 comprising a communication module 221, as well as a second sensing device 202, a third sensing device 203, and an N-th sensing device 204.

The communication module 221 of the first sensing device 201 can perform mutual communication with the communication modules (not shown) included in other sensing devices. For example, the first sensing device 201 can communicate with the second sensing device 202, the third sensing device 203, and the N-th sensing device 204. Similarly, the second sensing device 202 can communicate with the first sensing device 201, the third sensing device 203, and the N-th sensing device 204. Likewise, the third sensing device 203 can communicate with the first sensing device 201, the second sensing device 202, and the N-th sensing device 204, and the N-th sensing device 204 can communicate with the first sensing device 201, the second sensing device 202, and the third sensing device 203. Each individual sensing device may conduct short-range communication with a nearby sensing device via the communication network 20, perform long-range mobile communication, or carry out relay communication through a gateway.

Among these components, the communication module may include at least one component that enables communication with an external device, such as a broadcast reception module, a wired communication module, a wireless communication module, a short-range communication module, or a location information module. The wireless communication module may support various wireless communication standards, including but not limited to Wi-Fi, WiBro (Wireless Broadband), GSM (Global System for Mobile Communication), CDMA (Code Division Multiple Access), WCDMA (Wideband Code Division Multiple Access), UMTS (Universal Mobile Telecommunications System), TDMA (Time Division Multiple Access), LTE (Long-Term Evolution), 4G, 5G, and 6G.

The wireless communication module may include a wireless communication interface comprising an antenna and a transmitter for transmitting mobile communication signals. Additionally, under the control of a control unit, the wireless communication module may further include a mobile communication signal conversion module that modulates digital control signals output from the control unit into analog wireless signals.

The wireless communication module may also include a wireless communication interface with an antenna and a receiver for receiving mobile communication signals. Moreover, the wireless communication module may further include a mobile communication signal conversion module for demodulating the received analog wireless signals into digital control signals.

According to an exemplary embodiment of the present disclosure, when multiple sensing devices are located together within a predefined space, each of these devices may sequentially interact with one another, thereby establishing a foundation for acquiring diversified information about the space.

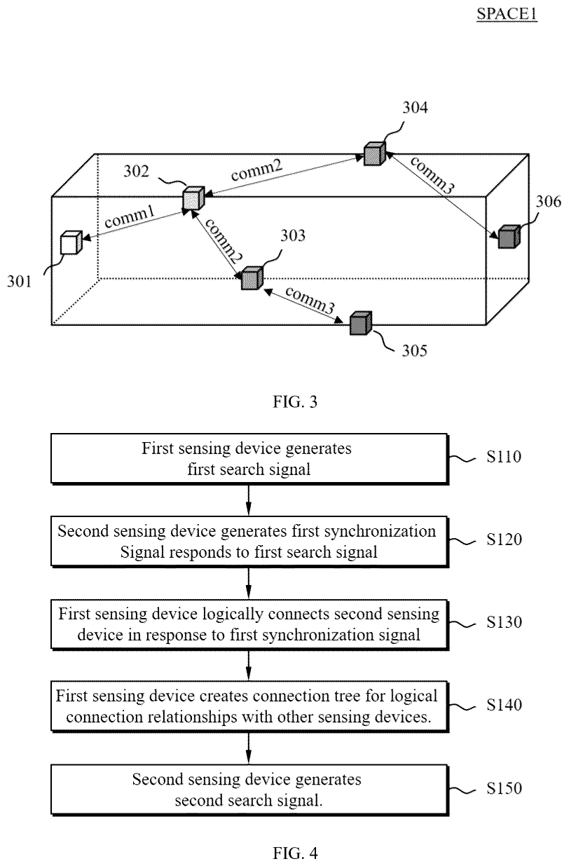

FIG. 3 is a conceptual diagram illustrating sensing devices arranged within a predefined space (SPACE1) according to an exemplary embodiment of the present disclosure. For ease of explanation, FIG. 3 shows six sensing devices 301, 302, 303, 304, 305, 306, but the technical scope of the present disclosure is not limited thereto, and various numbers and arrangements of sensing devices may be implemented.

Referring to FIG. 3, the first sensing device 301 may be logically connected to the adjacent second sensing device 302 through communication (comm1). The first sensing device 301 can receive sensing information from the second sensing device 302, including temperature, humidity, and other sensed data from the location where the second sensing device 302 is deployed. In an exemplary embodiment, the first sensing device 301 may also receive transport-related information such as the unique terminal information of the second sensing device 302, the network bandwidth in use, the deployment location, shipment and unloading details, and transport routes. Similarly, the second sensing device 302 can receive sensing and/or transport information from the first sensing device 301.

In another exemplary embodiment, the second sensing device 302 may be logically connected to the adjacent third sensing device 303 and fourth sensing device 304 through communication (comm2). The second sensing device 302 can receive sensing information such as temperature and humidity, as well as transport-related information (e.g., unique terminal information, network bandwidth, deployment location, shipment/unloading data, and transport routes) from the third sensing device 303 and the fourth sensing device 304. Likewise, the third sensing device 303 and the fourth sensing device 304 can receive sensing and/or transport information from the second sensing device 302.

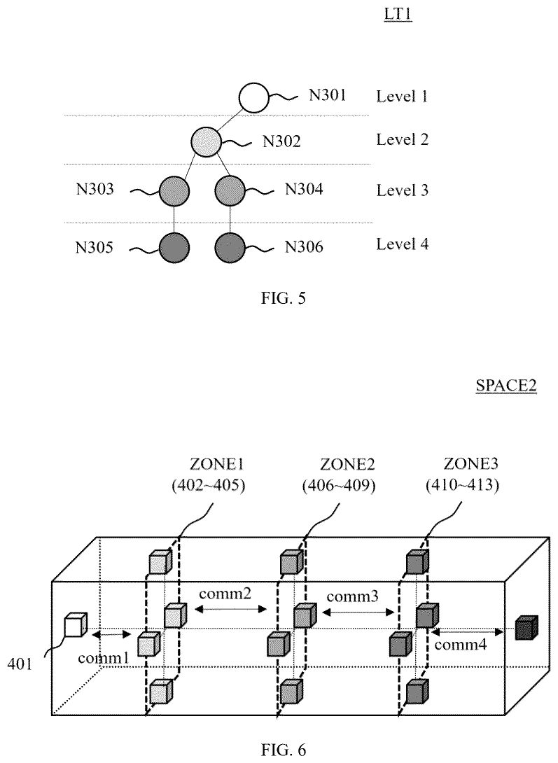

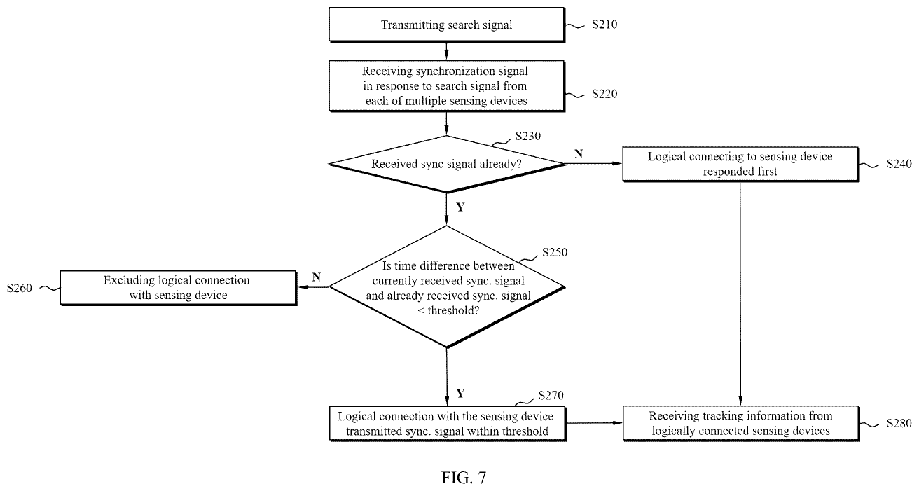

According exemplary embodiment, the initial connection communication between the third sensing device 303 and the fourth sensing device 304 with the second sensing device 302 may be established within a predefined time. In other words, since the third sensing device 303 and the fourth sensing device 304 are temporally proximate to the second sensing device 302, they may be classified into the same group. Further details on this will be described with reference to FIGS. 4 and 5.

In another exemplary embodiment, the third sensing device 303 may be logically connected to the fifth sensing device 305 through communication (comm3), and the fourth sensing device 304 may be logically connected to the sixth sensing device 306 through communication (comm3). The exchange of sensing and transport information between these devices is as previously described.

Since the third and fourth sensing devices 303, 304 are part of the same group due to their temporal proximity with the second sensing device 302, the fifth and sixth sensing devices 305, 306 may be treated as a subsequent logically connected group or utilize the communication (comm3) network in a similar manner.

If the fifth and sixth sensing devices 305, 306 fail to find subsequent devices to connect to, the logical connection process may end, and it may be assumed that all sensing devices within the predefined space (SPACE1) are logically connected. According to an exemplary embodiment, each sensing device can maintain its connection with all other sensing devices within the predefined space, enabling the acquisition of information from other devices regarding sensing data, location data, and/or potential loss or theft of goods.

Furthermore, any sensing device within the predefined space can be used to verify whether the correct number of sensing devices has been installed or retrieved. If each sensing device is individually attached to a cargo item, it can also be used to confirm whether the proper quantity of goods has been loaded and/or unloaded.

In an exemplary embodiment, sensing devices may further include a light-emitting unit composed of an organic light-emitting diode (OLED) element. If all sensing devices are logically connected at all times or temporarily triggered by a button press, they may display a first color (e.g., green). If any sensing device is not logically connected, they may display a second color (e.g., red). Additionally, the lighting unit or other visual indicators may be used to immediately notify users of the connection status or transmit the connection status information to a central control server.

FIG. 4 is a flowchart illustrating the interconnection between sensing devices according to an exemplary embodiment of the present disclosure. FIG. 4 will be described in conjunction with FIG. 3.

In step S110, the first sensing device may generate a first search signal. For example, referring to FIG. 3, the first sensing device 301 arranged within a predetermined space (SPACE1) may generate the first search signal to search for other sensing devices.

In step S120, the second sensing device may generate a first synchronization signal in response to the first search signal. For example, the second sensing device 302 arranged in the predetermined space (SPACE1) may generate the first synchronization signal in response to the first search signal.

In step S130, the first sensing device may logically connect to the second sensing device in response to the first synchronization signal. For example, the first sensing device 301 may logically connect to the second sensing device 302 upon receiving the first synchronization signal. The order and method of logical connection have already been described in connection with FIG. 3, and thus redundant descriptions are omitted.

In step S140, the first sensing device may generate a connection tree representing the logical connection relationships with other sensing devices. For example, the first sensing device 301 may generate a connection tree, which is a data structure representing the logical connection relationships with other sensing devices. The connection tree will be described in more detail with reference to FIG. 5.

In step S150, the second sensing device may generate a second search signal to search for other sensing devices for subsequent logical connections. For example, the second sensing device 302 may generate the second search signal to search for other sensing devices. As a result, the third sensing device 303 and the fourth sensing device 304 may be logically connected to the second sensing device 302. Once a specific sensing device is logically connected to another sensing device, the connected sensing device may generate a search signal to search for additional sensing devices for logical connection.

According to an exemplary embodiment, the second sensing device 302 may logically connect to the third sensing device 303 upon receiving the second synchronization signal. At this time, the second sensing device 302 may provide the first sensing device 301 with a connection tree representing its connection relationships with other sensing devices. In this case, the first sensing device 301 may update the connection tree, which is a data structure representing connection relationships. This process is repeated, and if no further synchronization signals are received, all sensing devices may be connected and synchronized.

According to an exemplary embodiment of the present disclosure, the search signal and synchronization signal are separated so that there is no risk of misidentifying a search signal as a synchronization signal or vice versa. To ensure this, signal-independent modulation methods may be used.

According to an exemplary embodiment, while the search signal and synchronization signal are conceptually separated, they may originate from the same relay signal. In this case, each sensing device may interpret the initially received relay signal as a search signal and the transmitted signal in response to the relay signal as a synchronization signal.

In this disclosure, the predetermined space (SPACE1) may be a cargo loading space for transportation, and at least one of the plurality of sensing devices 301 to 306 may be attached to the cargo.

FIG. 5 is a relational diagram schematically illustrating a connection tree (LT1) representing the interconnection of sensing devices according to an exemplary embodiment of the present disclosure. The connection tree (LT1) in this disclosure is a data structure representing the relationships between nodes, where each node corresponds to the sensing devices described above.

Referring to FIG. 5, the connection tree (LT1) may include a total of six nodes (N301, N302, N303, N304, N305, and N306). The connection tree (LT1) in FIG. 5 corresponds to the environment described in FIG. 3 and may align with the arrangement of sensing devices in FIG. 3.

The first node (N301), corresponding to the first sensing device 301, may be created (first level). The first node (N301) may be connected to the second node (N302), corresponding to the second sensing device 302, to which it is logically connected (second level). The second node (N302) may simultaneously connect to the third node (N303), corresponding to the third sensing device 303, and the fourth node (N304), corresponding to the fourth sensing device 304 (third level). Similarly, the third node (N303) may connect to the fifth node (N305), and the fourth node (N304) may connect to the sixth node (N306). Since the fifth node (N305) and the sixth node (N306) originate from the same level, they may also belong to the same fourth level.

According to an exemplary embodiment, if a sensing device that has received the first search signal subsequently receives another first synchronization signal from a different sensing device, it may cease generating its own synchronization signal. Once a logical connection is established between two different nodes, additional connections with other sensing devices outside the designated interest area or target cargo may no longer be necessary.

According to an exemplary embodiment, to ensure data integrity, the connection tree (LT1) must be unique. Therefore, once a search signal is generated, no additional search signals should be generated, and once a synchronization signal is generated, no additional synchronization signals should be created.

According to an exemplary embodiment, each of the plurality of sensing devices 301 to 306 may generate the search signal and synchronization signal only once. As a result, no additional synchronization or search signals are generated by other sensing devices, thereby suppressing node branching in the connection tree (LT1) and ensuring the uniqueness of the connection tree.

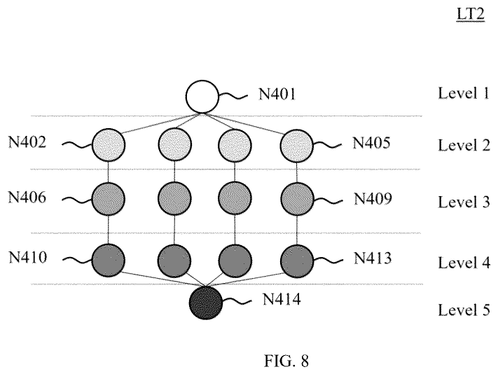

FIG. 6 is a conceptual diagram schematically illustrating sensing devices arranged in a predetermined space (SPACE2) according to an exemplary embodiment of the present disclosure.

Referring to FIG. 6, the first sensing device 401 may be logically connected by communicating (comm1) with the adjacent second sensing device 402, third sensing device 403, fourth sensing device 404, and fifth sensing device 405. The second sensing device 402, third sensing device 403, fourth sensing device 404, and fifth sensing device 405 are located at similar distances from the first sensing device 401, and their respective synchronization signals, which respond to the exploration signal, all arrive with a time difference below a threshold, allowing them to be clustered into the first zone (ZONE1). The first sensing device 401 can receive sensing information, including temperature and humidity detected at the positions where each of the sensing devices 402 to 405 is deployed, from the sensing devices included in the first zone (ZONE1). In an exemplary embodiment, in addition to sensing information, the first sensing device 401 can further receive transportation information, including the unique terminal information, the utilized network bandwidth, deployment location, shipping and unloading information, and transport route of the sensing devices included in the first zone (ZONE1). In another exemplary embodiment, the sensing devices 402 to 405 included in the first zone (ZONE1) can receive sensing information and/or transportation information from the first sensing device 401.

According to an exemplary embodiment, the sensing devices 402 to 405 included in the first zone (ZONE1) can be logically connected by communicating (comm2) with the sensing devices 406 to 409 included in the adjacent second zone (ZONE2). The sensing devices 402 to 405 included in the first zone (ZONE1) can receive sensing information, such as temperature and humidity detected at the positions where the sensing devices 406 to 409 of the second zone (ZONE2) are deployed, and/or transportation information, including terminal-specific information, utilized network bandwidth, deployment location, shipping and unloading details, and transport routes, from the sensing devices 406 to 409 in the second zone (ZONE2). Likewise, each of the sensing devices 406 to 409 included in the second zone (ZONE2) can receive sensing information and/or transportation information from the sensing devices 402 to 405 included in the first zone (ZONE1), as described above.

Similarly, the sensing devices 406 to 409 included in the second zone (ZONE2) can establish a logical connection by communicating (comm3) with the sensing devices 410 to 413 included in the third zone (ZONE3). The sensing devices 410 to 413 included in the third zone (ZONE3) can communicate (comm4) with the fourth sensing device 414.

According to an exemplary embodiment of this disclosure, each sensing device 410 to 413 included in the third zone (ZONE3) can generate an exploration signal, and the fourth sensing device (414) can generate a synchronization signal in response to the exploration signal transmitted from any one of the sensing devices 410 to 413 included in the third zone (ZONE3). In this case, even though the communication of the synchronization signal occurs between two sensing devices, a connection relationship between all the sensing devices 410 to 413 in the third zone (ZONE3) and the fourth sensing device (414) can be established.

According to an exemplary embodiment of this disclosure, the fourth sensing device 414 may terminate the logical connection upon failing to discover a subsequent sensing device for logical connection, thereby assuming that all sensing devices within a predetermined space (SPACE2) are logically connected.

For the sake of convenience in explanation, this disclosure illustrates the connection relationship with the nearest sensing device that first transmitted a synchronization signal. However, the technical concept of this disclosure is not limited thereto.

According to an exemplary embodiment of this disclosure, at least one of the sensing devices may be designated as a target sensing device, a specific area where sensing devices are installed may be designated as a target area, or sensing devices deployed on a particular cargo (e.g., a high-value item such as a battery) may be preferentially logically connected.

In an exemplary embodiment, a sensing device may have multiple operating modes. For example, in the first operating mode, the sensing device may store the connection relationship with the nearest sensing device that transmitted the first received synchronization signal among multiple synchronization signals, or in the second operating mode, it may store the connection relationship with the target sensing device deployed in the designated target area among multiple synchronization signals.

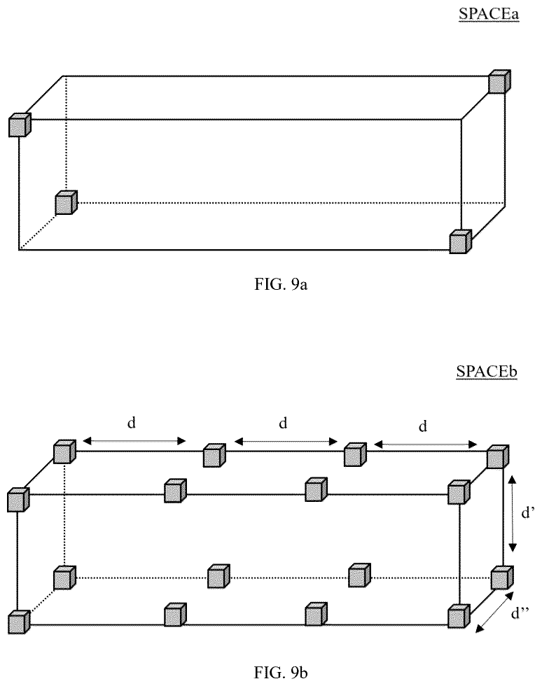

FIG. 7 is a flowchart illustrating the interaction between sensing devices according to an exemplary embodiment of the present disclosure. FIG. 7 is referenced in conjunction with FIG. 6.

In step S210, the first sensing device 401 may generate an exploration signal and broadcast it.

In step S220, the first sensing device 401 may receive multiple synchronization signals from various sensing devices 402 to 405 responding to the exploration signal. For example, the first sensing device 401 may receive synchronization signals from each sensing device 402 to 405 included in the first zone (ZONE1), as well as synchronization signals received from sensing devices 406 to 409 included in the second zone (ZONE2) and sensing devices 410 to 413 included in the third zone (ZONE3).

In step S230, the first sensing device 401 may determine whether it has already received a synchronization signal. If the first sensing device 401 has not previously received a synchronization signal, it may establish a logical connection with the first responding sensing device (step S240).

In step S250, if the first sensing device 401 has already received a synchronization signal, it may determine whether the time difference between the newly received synchronization signal and the previously received synchronization signal is below a threshold.

In step S260, if the time difference between the first received synchronization signal and the second received synchronization signal exceeds the threshold, the first sensing device 401 may exclude the corresponding sensing device from the logical connection. As a result, the first sensing device 401 may cluster only those sensing devices that have sent synchronization signals with time differences within the threshold, avoiding logical connections with the remaining sensing devices.

In step S270, the first sensing device 401 may establish a logical connection with sensing devices that have transmitted synchronization signals within the threshold. For example, if the time difference between the first received synchronization signal and the second received synchronization signal is within the threshold, the first sensing device 401 may logically cluster all the sensing devices that transmitted those signals as a single group. This allows the first sensing device 401 to cluster all sensing devices that transmitted synchronization signals within the threshold.

In step S280, the first sensing device 401 may receive tracking information from the logically connected sensing devices. In the present disclosure, tracking information includes sensed data such as temperature and humidity detected at each sensing device's location, as well as terminal-specific information, the network band in use, deployment location, shipping information, and unloading and transportation route data.

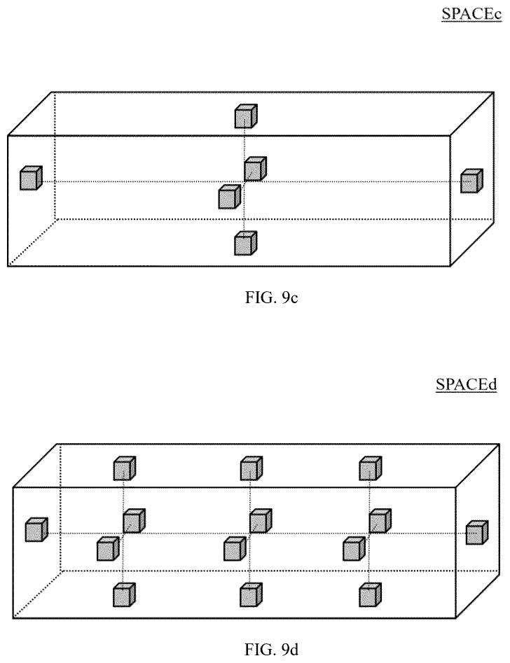

FIG. 8 is a schematic diagram showing a connection tree for the interaction between sensing devices according to an exemplary embodiment of the present disclosure.

Referring to FIG. 8, the connection tree (LT2) may consist of a total of 14 nodes (N401, N402, N403, N404, N405, N406, N407, N408, N409, N410, N411, N412, N413, and N414). The connection tree (LT2) of FIG. 8 applies within a given environment depicted in FIG. 6 and corresponds to the sensing device placement arrangement in FIG. 6.

A first node (N401) corresponding to the first sensing device 401 may be generated (first level). The first node (N401) may be logically connected to a second node (N402), a third node (N403), a fourth node (N404), and a fifth node (N405), each corresponding to second sensing devices 402 to 405 (second level).

Each of the second, third, fourth, and fifth nodes (N402, N403, N404, and N405), included in the second zone (ZONE2), may be connected to nodes corresponding to logically connected sensing devices located at the shortest distance. For example, the nodes (N402 to N405) in ZONE2 may be logically connected to nodes (N406 to N409) in the third zone (ZONE3) (third level).

Similarly, the nodes (N406 to N409) in the third zone (ZONE3) may be logically connected to nodes (N410 to N413) in the fourth zone (ZONE4) (fourth level). The nodes (N410 to N413) in the fourth zone (ZONE4) may be logically connected to node N414 (fifth level).

According to an exemplary embodiment, node N414 may terminate the formation of the connection tree if no synchronization signal is received in response to the exploration signal.

According to another exemplary embodiment, if any sensing device that has received a first exploration signal also receives a first synchronization signal from another sensing device, it may stop generating its own synchronization signal. Since the logical connection between two different nodes is completed, further connections with sensing devices outside of the closest, designated interest area, or interest cargo may no longer be necessary.

According to an exemplary embodiment, the connection tree (LT1) must be unique to ensure data integrity. Therefore, once an exploration signal has been generated, no additional exploration signal should be generated, and once a synchronization signal has been generated, no additional synchronization signal should be generated.

In an exemplary embodiment, each of the multiple sensing devices 401 to 414 may generate the exploration and synchronization signals only once. This prevents additional synchronization or exploration signals from being generated by other sensing devices, thereby suppressing node proliferation in the connection tree (LT2) and ensuring the uniqueness of the connection tree.

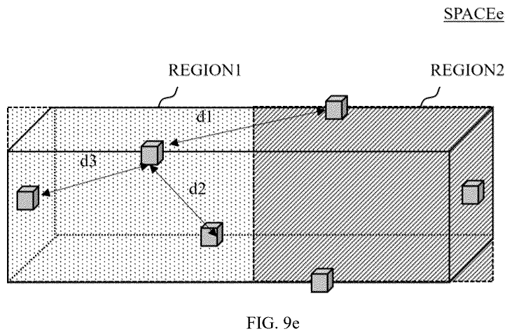

FIGS. 9a, 9b, 9c, 9d, and 9e are conceptual diagrams schematically illustrating sensing device placements in a given space according to an exemplary embodiment of the present disclosure.

Referring to FIG. 9a, sensing devices are shown occupying the four vertices of a rectangular parallelepiped space (SPACEa). For example, to maximize sensing efficiency in space (SPACEa), each sensing device needs to be positioned at the maximum possible separation distance. Therefore, the sensing devices may be placed in ‘twisted positions’ at opposite diagonal corners. In this case, only four sensing devices are required to be optimally positioned in the space. Assuming that space (SPACEa) is composed of x-y, y-z, and z-x planes, the sensing devices may be interpreted as being positioned at the farthest distances along the x-y plane, y-z plane, and z-x plane.

According to another exemplary embodiment, space (SPACEa) may be interpreted as a rectangular parallelepiped. Assuming the number of sensing devices is “4,” four devices may be placed at any four of the eight vertices of the rectangular parallelepiped. The number of possible combinations for placing four devices among the eight vertices corresponds to the mathematical combination formula

$${C}_{4}^{8} .$$

A logistics integration system or server may calculate the average separation distance for each

$${C}_{4}^{8}$$

combination and determine the combination with the maximum average separation distance as the optimal sensing device placement.

Referring to FIG. 9b, sensing devices are shown occupying the edges of a rectangular parallelepiped space (SPACEb). If the conditions of the transportation environment allow sensing devices to be placed along the edges, the placement configuration of FIG. 9b may be applied.

For example, to maximize sensing efficiency in space (SPACEb), each sensing device needs to be positioned at the maximum possible separation distance. Since the edge length is fixed, each sensing device must be evenly spaced. Therefore, the sensing devices may be positioned at a first predetermined distance (d) apart in the horizontal direction, at a second predetermined distance (d′) apart in the vertical direction, and at a third predetermined distance (d″) apart in the height direction.

According to an exemplary embodiment, the logistics integration system or server may arrange sensing devices at equal intervals along the x-axis at the first distance (d), place them along the y-axis at a second distance (d′) that deviates from the first distance within a second threshold, and place them along the z-axis at a third distance (d″) that deviates from the first and second distances within the second threshold. In this case, the number of required sensing devices may be a multiple of four.

Referring to FIG. 9C, a sensing device occupying the center of the faces in a three-dimensional rectangular space (SPACEc) is shown. If the six planes constituting the space allow for the placement of sensing devices due to transportation conditions, the arrangement in FIG. 9C can be applied. For example, to maximize sensing efficiency in SPACEc, each sensing device needs to achieve the maximum separation distance. Since the number of faces is fixed, the number of sensing devices may be limited. In this case, six sensing devices may be required.

Referring to FIG. 9D, a sensing device occupying the center of the faces in a three-dimensional rectangular space (SPACEd) is shown. If the six internal faces constituting the space allow for the placement of sensing devices due to transportation conditions, the arrangement in FIG. 9D can be applied. For example, to maximize sensing efficiency in SPACEd, each sensing device needs to achieve the maximum separation distance. Since the number of faces is fixed, the number of sensing devices may be limited. In this case, a multiple of six sensing devices may be required.

According to an exemplary embodiment, the logistics integration system or server may arrange the sensing devices at equal intervals along the x-y plane, y-z plane, and z-x plane. In this case, the number of required sensing devices may be 14.

Referring to FIG. 9E, sensing devices occupying both the first region (REGION1) as an area of interest and the second region (REGION2) as a non-interest area in a three-dimensional rectangular space (SPACEe) are illustrated. For example, the sensing information of the area of interest may be more critical than that of the non-interest area for sensing efficiency in SPACEe.

According to an exemplary embodiment, the logistics integration system or server may determine whether zoning is necessary for the space. For instance, the logistics integration system or server may determine the necessity of zoning in cases such as last-in, first-out (LIFO) logistics for vehicle transportation, when high-value goods (e.g., batteries) and low-value goods are mixed, when temperature and/or humidity-sensitive goods (e.g., industrial electronic equipment) are combined with less sensitive goods, when control over the effects of inertia on vehicles or trains is required, or when air inflow and temperature variations due to door openings and closings must be managed.

According to an exemplary embodiment, the logistics integration system or server may separate the composite structure into zones using the minimum number of deployable sensing devices among the 12 edges, 6 faces, and 4 vertices constituting the space and determine the number and arrangement of the deployed sensing devices.

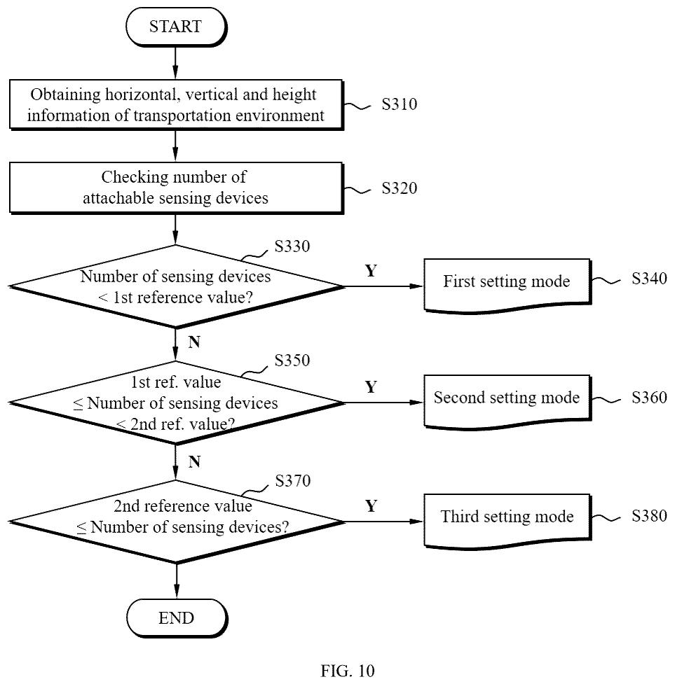

FIG. 10 is a flowchart explaining a method for arranging sensing devices within a predetermined space according to an exemplary embodiment. Although not explicitly depicted in the drawings, a logistics integration system, operated via an application and connected to multiple sensing devices through a server or network, is assumed. The server or logistics integration system can manage the placement of sensing devices in the designated space, each sensing device within the space, and the sensing data obtained from them, such as temperature, humidity, vibration, and gas levels.

In step S310, the width, length, and height of the transportation environment are obtained. The transportation environment corresponds to a designated space (SPACE), such as a cargo compartment in a freight vehicle, a storage hold in an aircraft or ship, a unit transport space such as a container box, a reefer container, or a liner, or any physically partitioned area for transporting goods. However, it is not limited to physically enclosed spaces; even without physical barriers, any space where a dedicated communication network 20 can be established within a certain distance from the sensing device may be included.

In step S320, the number of attachable sensing devices is determined. The server or logistics integration system identifies the total number of deployable, arranged, and attachable sensing devices based on the width, length, and height of the transportation environment, space characteristics (such as temperature control capability in a reefer container), and the presence of high-value goods (e.g., batteries). For instance, in a general cargo transportation environment, the minimum required number of sensing devices may be four, whereas in a high-value cargo transportation environment, up to 100 sensing devices may be deployed.

In step S330, it is determined whether the number of sensing devices is below the first threshold. If the number of deployable sensing devices is below the first threshold, the placement count and configuration of the sensing devices are determined according to the first configuration mode (S340). In this disclosure, assuming the first threshold is set at “5,” the number of deployable sensing devices in the transportation environment may be determined as “4” through the first configuration mode. Of course, the specified numbers are merely exemplary and may vary depending on various transportation environments and determining factors.

In step S350, it is determined whether the number of sensing devices is equal to or greater than the first threshold but less than the second threshold. If the number of deployable sensing devices falls within this range, the second configuration mode is applied (S360). In this disclosure, assuming the second threshold is “9,” the number of deployable sensing devices in the transportation environment may be determined as “8” through the second configuration mode. Again, these numbers are exemplary and may vary based on various transportation conditions.

In step S370, it is determined whether the number of sensing devices is equal to or greater than the second threshold. If the number of deployable sensing devices meets or exceeds the second threshold, the third configuration mode is applied (S380). In this disclosure, assuming the second threshold is “9,” if more than nine sensing devices can be deployed, the third configuration mode determines the number of deployable sensing devices, such as “10” or “14,” to accommodate various measurement requirements based on the arrangements illustrated in FIGS. 9A to 9E. Naturally, the specified numbers are only examples and may vary depending on the transportation environment and determining factors.

### 2. EXAMPLE 2

A different example is presented below. This example describes a method for estimating environmental information in a cargo transportation space. It should be understood that, in this disclosure, the reference numerals of Example 2 may indicate different configurations, even if they are assigned the same numbers or characters as those in Example 1.

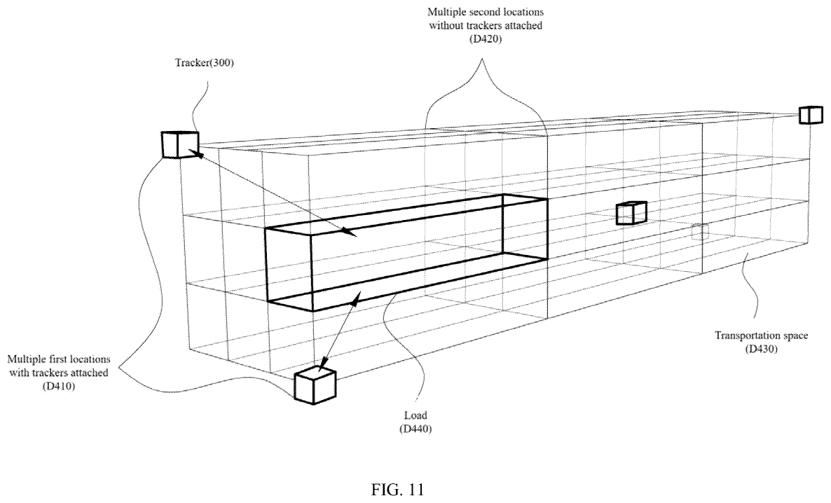

FIG. 11 illustrates a three-dimensional image of a transportation space to which a temperature measurement sensor 300 is attached, according to one embodiment.

Referring to FIG. 11, the transportation space (D430) may have a rectangular parallelepiped shape, and its form may be displayed as a predetermined three-dimensional spatial image. The temperature measurement sensor 300 may be attached at multiple locations corresponding to the vertices of the rectangular parallelepiped (plurality of first positions, D410). These multiple first positions may be predetermined by a user and may represent a value of two or more and four or fewer.

Meanwhile, the vertices inside the transportation space that are not equipped with temperature measurement sensors 300 may be designated as a plurality of second positions (D420). That is, in the plurality of second positions, the count may range from four to six.

As shown in FIG. 11, cargo (D440) may be positioned within the transportation space (D430). The cargo (D440) may be placed at a predetermined location within the transportation space (D430), with its position set based on a user-defined reference point (origin), thereby forming three-dimensional coordinates (x, y, z).

Accordingly, the position of the cargo (D440), which is required for the distance measurement sensor 400 to generate distance data, can be determined for each of the x, y, and z three-dimensional coordinates. For example, if the temperature measurement sensor 300 is set as the origin in FIG. 11, the coordinates of the first position where the temperature measurement sensor 300 is attached may be (0, 0, 0). Another point among the plurality of first positions where another temperature measurement sensor is attached may have coordinates of (0, 3, −3) (D410). The cargo (D440) may be positioned at coordinates such as (3, 1.5, −1.5) based on the center of the cargo.

Since each of the plurality of second positions can be represented in three-dimensional coordinates, three-dimensional temperature data can be generated for each of the x, y, and z coordinate axes. The estimated vertex temperature data may be determined as either the arithmetic mean value or the RMS (Root Mean Square) value of the temperature data for the x-coordinate (Tx), the y-coordinate (Ty), and the z-coordinate (Tz).

For example, if (Tx, Ty, Tz)=(8, 10, 9), the estimated vertex temperature data may be determined as either the arithmetic mean value of 9 or the RMS value of approximately 9.04.

Referring to FIG. 11, D420 represents a plurality of second positions where temperature measurement sensors are not attached.

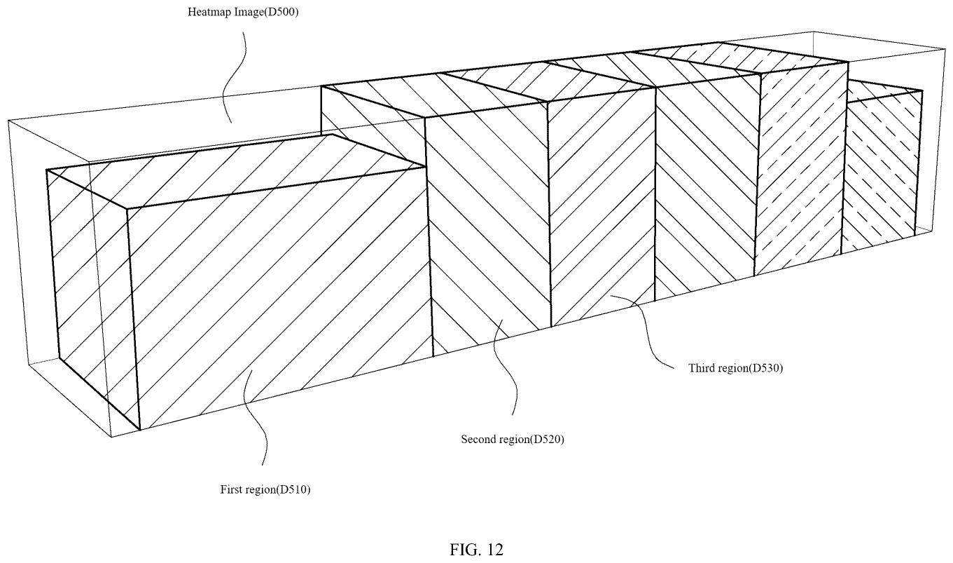

FIG. 12 schematically illustrates a heatmap image of a cargo transportation space where temperature has been measured and estimated, according to one embodiment.

Referring to FIG. 12, when the transportation space is displayed as a three-dimensional spatial image, according to one embodiment of the present disclosure, a plurality of estimated cargo temperature data can be generated based on a plurality of measured temperature data and a plurality of estimated transportation space temperature data for a plurality of cargo items. Subsequently, a heatmap image (D500) displaying the measured temperature data, estimated transportation space temperature data, and estimated cargo temperature data can be presented on a user interface.

A heatmap is a combination of the words “heat” and “map,” referring to a visual graphic that represents various types of information as a heat distribution pattern in an image using colors. By providing a heatmap image, it becomes easier to track temperature changes in cargo stored inside the transportation space over time.

Referring to FIG. 12, different estimated cargo temperature data may be generated for each of the first region (D510), second region (D520), and third region (D530) based on a predetermined second estimation algorithm, and these regions may be represented with different temperatures in the heatmap image (D500).

The process of generating edge-estimated temperature data from the measured temperature data at the first positions where temperature measurement sensors are attached, the estimated vertex temperature data, and the distance data may follow Equation 1.

$$T ( x ) = {A}^{*} L ( x ) + {T}_{0} \qquad [ Equation 1 ]$$

(T(x): Temperature at point x on the edge, A: Temperature increase rate at the vertex, L(x): Distance along the edge from the initial position to point x, T₀: Temperature at the initial position)

Since the edges correspond to the x, y, and z axes in a three-dimensional coordinate system, the mathematical equation 1 can be applied to each of the x, y, and z coordinates, yielding T(x), T(y), and T(z) for each respective axis.

For example, considering the x-coordinate, if the temperature at a first position is 10° C. and the temperature at a second position along the same axis is 12° C., and the distance between these two positions is 10 m, the first position is set as the initial position with A=+0.2° C./m. Thus, the temperature along the edge can be determined using the equation: T(x)=0.2*L(x)+10 (where L(x)≤10). Accordingly, the temperature of the edge between the first and second positions along the x-axis can be estimated using the above equation, thereby generating edge temperature estimation data. Based on this algorithm, the edge temperature estimation data for each of the x, y, and z coordinates can be predicted and generated.

In exemplary an embodiment, surface temperature estimation data can be generated for each of the multiple surfaces within a rectangular transportation space. For example, the process of generating surface temperature estimation data from the edge temperature estimation data and distance data follows Equation 2, which is as follows.

$$T ( x ) = {B}^{*} L ( x ) + {T}_{0} \qquad [ Equation 2 ]$$

(T(x): Temperature of the plane, B: Rate of temperature increase at the edge, L(x): Vertical distance from the initial point to the line on the plane parallel to the long edge where the initial point is located, T₀: Temperature at the initial point)

According to one embodiment of the present invention, based on the x-coordinate, if the temperature at a first position is measured as 10° C. and the temperature at a second position along the same axis is estimated as 12° C., the temperature of the edge connecting the first and second positions is determined to be the RMS (Root Mean Square) average of the temperatures at these positions, which is 11.51° C. Assuming that this edge temperature represents the temperature of one of the long edges of a plane, and the temperature of the other parallel long edge is given as 13° C. based on the same RMS averaging method, if the vertical distance between these two parallel long edges is 5 m, then setting the edge at 11.51° C. as the initial point, and with B=+0.098° C./m, the temperature distribution along the plane can be determined as: T(x)=0.098×L(x)+11.51 (where L(x)≤5). Thus, the temperature of the plane within the transportation space that includes these two parallel long edges can be determined based on this mathematical equation, enabling the generation of estimated plane temperature data.

According to another embodiment of the present invention, if the estimated edge temperature data of two long and parallel edges within the transportation space are determined by an estimation algorithm as: T₁(x)=0.2×L₁(x)+10, T₂(x)=0.1×L₂(x)+12 then the estimated plane temperature data can be determined as: T₃(x)=0.15×L₃(x)+11, where T₃(x) corresponds to the line bisecting the smaller angle between the two linear equations of T₁(x) and T₂(x), representing the temperature of the plane that includes both parallel edges.

The estimated transportation space temperature data can be generated according to a predetermined estimation algorithm based on the temperatures of wide, parallel planes in the transportation space.

If the transportation space is formed as a rectangular parallelepiped, the estimated transportation space temperature data may include estimated temperature data for any of the vertices, edges, planes, or the entire transportation space where no temperature measurement sensors are attached.

The estimation algorithm may refer to an algorithm that generates estimated plane temperature data for each plane of the rectangular parallelepiped transportation space based on the temperatures of wide, parallel planes in accordance with the following equation (Equation 3):

$$T ( x ) = {C}^{*} L ( x ) + {T}_{0} \qquad [ Equation 3 ]$$

(T(x): Temperature of the space, C: Rate of temperature increase of the surface, L(x): Vertical distance from the initial point to the line on the surface parallel to the initial point's surface, T₀: Temperature at the initial point)

According to one embodiment of the present invention, if the temperature of the first long edge of a surface is estimated to be 10° C. (RMS average value) based on an estimation algorithm and the temperature of the second long edge, which is parallel to the first long edge, is estimated to be 12° C. (RMS average value), then the temperature of the surface connecting the first and second long edges is determined to be 11.51° C., which is the RMS average value of the first and second long edges. If the temperature of this surface is considered the temperature of the largest surface among three pairs of parallel surfaces in a transport space and the temperature of another parallel large surface is 15° C., as determined by the same RMS averaging method, and the vertical distance between the two parallel surfaces is 10 m, then using the surface at 11.51° C. as the initial point, with C=+0.349° C./m, the temperature T(x) of the transport space can be determined as T(x)=0.349*L(x)+11.51 (where L(x)≤10). Accordingly, the transport space's estimated temperature data can be generated based on the Equation 3.

In another embodiment of the present invention, if the estimated temperature data of two parallel large surfaces in the transport space, determined based on the estimation algorithm, are T1(x)=0.2*L1(x)+10 and T2(x)=0.1*L2(x)+12, respectively, then the bisecting line of the small angle formed by the linear equations of T1(x) and T2(x), represented by T3(x)=0.15*L3(x)+11, can be determined as the estimated temperature data of the transport space that includes the two parallel surfaces.

In an exemplary embodiment, the process may involve generating estimated cargo temperature data based on estimated cargo location temperature data and a pre-determined estimation algorithm that incorporates heat transfer coefficients. The estimation algorithm may generate cargo temperature data based on the cargo location temperature data and the thermal transmittance value, which is pre-stored in memory and matched with the medium and packaging thickness of the cargo.

Meanwhile, the heat quantity of the cargo may be determined based on the equation: Cargo heat quantity=Cargo location temperature (° C.)×Thermal transmittance (kcal/m²hΔ° C.). The cargo temperature may then be determined based on the equation: Q=c*m*Δt (where c is the specific heat capacity of the material, m is the mass of the material, and. At is the temperature change of the material), leading to: Δt=Q/(c*m).

The present disclosure has been described with reference to the embodiments illustrated in the drawings, but these are merely exemplary. Those skilled in the art will understand that various modifications and equivalent implementations are possible. Therefore, the true technical scope of the present disclosure should be determined by the technical idea presented in the appended claims.

1: A method for linking a plurality of sensing devices, comprising:
generating, by a first sensing device disposed in a space, a first search signal to search for other sensing devices;
generating, by a second sensing device disposed in the space, a first synchronization signal in response to the first search signal;
logically connecting, by the first sensing device, the second sensing device in response to receiving the first synchronization signal;
generating, by the first sensing device, a connection tree as a data structure representing logical connection relationships with other sensing devices;
storing, by the first sensing device, a connection relationship with other sensing devices disposed within an area of interest according to a transition to a specific mode;
clustering, by the first sensing device, both of the sensing devices respectively having transmitted the first received synchronization signal and a second received synchronization signal into a single logical group when a time difference between the first and the second received synchronization signal is less than or equal to a threshold; and
generating, by the second sensing device, a second search signal to search for another sensing device.

2: The method of claim 1, further comprising:
logically connecting, by the second sensing device, a third sensing device in response to receiving a second synchronization signal generated from the third sensing device;
providing, by the second sensing device, its connection relationship to the first sensing device; and
updating, by the first sensing device, the connection tree as a data structure according to the connection relationship.

3: The method of claim 1, wherein the first sensing device: includes a plurality of operation modes, and is configured to:
store a connection relationship with a nearest sensing device that transmitted a first received synchronization signal among a plurality of received synchronization signals according to a first operation mode, or
store a connection relationship with the target sensing device disposed within an area of interest among a plurality of received synchronization signals according to a second operation mode.

4. (canceled)

5: The method of claim 1, wherein the second sensing device stores a connection relationship with the first sensing device in response to generating the first synchronization signal.

6: The method of claim 1, further comprising:
stopping, by a fourth sensing device that received the first search signal, the generation of its own synchronization signal upon receiving the first synchronization signal.

7: The method of claim 1, wherein the space is a cargo loading space for transportation, and at least one of the plurality of sensing devices is attached to the cargo.

8: The method of claim 1, wherein each of the plurality of sensing devices generates a synchronization signal only once.

9: The method of claim 8, wherein the second sensing device terminates the additional creation of connection relationship based on no synchronization signal is received in response to the transmission of the second search signal.

10: A sensing device disposed in a space, comprising:
a memory configured to store a connection relationship with other sensing devices disposed in the space according to a transition to a specific mode;
a communication module configured to support short-range communication with at least one sensing devices;
a sensor subsystem configured to sense environmental information including temperature or humidity; and
a processor configured to:
generate a connection tree according to connection relationships with the at least one sensing device,
process sensing information, and
cluster both of the sensing devices respectively having transmitted the first received synchronization signal and a second received synchronization signal into a single logical group when a time difference between the first and the second received synchronization signal is less than or equal to a threshold.
